(19) United States
(12) Patent Application Publication
(10) Pub. No.: US 2026/0218450 A1
(43) Pub. Date: Jul. 30, 2026

(54) Dewatering Element for Dewatering a Fibrous Web

(71) Applicant: ANDRITZ AG, Graz (AT)

(72) Inventor: Youping Huang, Kirchbach Zerlach (AT)

(21) Appl. No.: 19/143,664

(22) PCT Filed: Nov. 13, 2023
(86) PCT No.: PCT/EP2023/081609

§ 371 Date: Jun. 26, 2025

(30) Foreign Application Priority Data
Jan. 26, 2023 (AT) A 50040/2023

(51) Int. Cl. D21F 1/48; C04B 35/78

(52) U.S. Cl. CPC D21F 1/483; C04B 35/78

(57) ABSTRACT

A dewatering element for dewatering a fibrous web has a wear body with a sliding surface. The wear body is formed as a ceramic-reinforced polymer substrate. The dewatering element can be advantageously manufactured and recycled.

### BACKGROUND

The disclosed embodiments relate to a dewatering element for dewatering a fibrous web guided on a clothing over the dewatering element, comprising a wear body which forms a sliding surface, wherein the clothing can be guided over the wear body in direct contact with the sliding surface for dewatering the fibrous web, and further relates to a dewatering device for use in a machine for producing the fibrous web, in particular a paper or pulp web, that includes the dewatering element.

To produce a fibrous web, in particular a paper or pulp web, a fibre stock suspension is formed and fed to the sheet forming unit of the machine via a headbox. In the sheet forming unit, the fibrous web is formed from the suspension by dewatering. For this purpose, the suspension is guided onto a clothing, whereby the clothing is in turn guided over the various dewatering elements, such as dewatering strips, or dewatering devices, such as a forming shoe or a dewatering table. This ensures direct contact between the clothing and the dewatering element, wherein the dewatering element forms a sliding surface for the clothing. The typically high machine and clothing speeds of e.g. 2000 m/min and the abrasive effect of the clothing moving relative to the dewatering elements place high demands on the dewatering elements. On the one hand, the frictional resistance of the sliding surface should be minimised in order to achieve the lowest possible frictional power. On the other hand, the wear on the sliding surface of the dewatering elements should be minimised in order to ensure the longest possible operating time of the clothing and the dewatering elements.

Dewatering elements are known from the state of the art that allow an optimum compromise between frictional resistance and wear. EP4101977, for example, discloses a scraper blade. This is made of metal or synthetic material and is designed with a large number of wear elements made of a wear-resistant material, in particular surface-ground ceramic plates, on the upper side facing the sieve belt. The wear elements are mounted on a supporting bar and lined up in the direction of the longitudinal extent of the scraper blade. EP4101977 also states that scraper blades, which can be up to 12 metres long, must be manufactured precisely to the respective width of the paper machine and must therefore be produced individually, with the disadvantage that this design is expensive, requires long delivery times and cannot be produced in stock.

The WO9605370 A1 discloses a dewatering element comprising a body and a ceramic wear surface, wherein the ceramic wear surface is formed by a ceramic coating layer applied to a surface of the body by a heat spray coating process.

Furthermore, the WO0048747 A1 discloses a method for repairing localised damage and/or for sealing the porosity of wear surfaces, wherein a sealing agent containing a synthetic polymer can be cured by electromagnetic radiation.

The U.S. Pat. No. 3,975,568 A discloses a material suitable for contact with a forming fabric of a Fourdrinier machine, the material comprising abrasion resistant particles, which particles are uniformly distributed and incorporated in a plastic matrix, wherein the incorporation of the particles takes place as a monolayer in the matrix, and which monolayer forms a surface for abrasion. The DE102018123406 B3 discloses a dewatering device comprising a plurality of dewatering blades, wherein the material of the dewatering blade can be a polymer, and fillers such as glass (glass beads) or ceramic particles can be embedded in the polymer.

Finally, DE2318108 A1 discloses a composite material, wherein at least one surface consists of abrasion-resistant particles embedded in a matrix, the particles being arranged so that their surfaces are exposed.

### SUMMARY

Disclosed herein is a dewatering element whose wear body can be easily produced, whereby the wear body can be easily adapted to the respective width of the paper machine and, in particular, can easily be designed in one piece over the entire width of the dewatering element. Also provided is a dewatering element in which the recyclable materials contained in the wear body can be easily recycled after use and, in particular, can be reused in the manufacture of wear bodies for dewatering elements.

This is achieved by the wear body being designed as a ceramic-reinforced polymer substrate, with ceramic particles being incorporated into the polymer substrate. The wear body is thus designed as a polymer substrate, whereby ceramic particles are incorporated into the polymer substrate, which cause the ceramic reinforcement of the polymer substrate. A clothing guided over the wear body is in direct contact with the wear body via the sliding surface. The ceramic reinforcement of the polymer substrate, i.e. the particles embedded in the polymer substrate, are responsible for the high resistance to abrasion. In particular, a higher ceramic content in the wear body improves abrasion resistance and wear resistance. According to the definition of a ceramic, the ceramic particles are made of a material with a crystalline or crystalline/amorphous structure or microstructure. The design of the wear body as a polymer substrate is advantageous in itself, as the polymer substrate gives the wear body improved strength, in particular impact resistance, and improved toughness or reduced brittleness. In particular, the polymer substrate gives the wear body the advantageously low coefficient of friction and thus the low frictional resistance, whereby the polymer substrate fills the cavities between the ceramic particles and enables the formation of an essentially smooth sliding surface of the wear body. The characteristics thus provide a synergistic effect. The positive effects, such as the high abrasion resistance of the ceramic particles, which in themselves are not very impact-resistant, overlap with the positive effects of the polymer substrate, such as the improvement in the impact resistance of the wear body and, in particular, the development of low frictional resistance. Advantageously, the wear body according to the invention allows repair, in particular by repairing localised defects. Such localised defects are formed as spallings, for example. For repair, the localised defect is simply treated with the ceramic-reinforced polymer substrate or the spalling is closed. In addition, a simple design of the wear body is possible. There are also no significant restrictions with regard to the achievable width of the dewatering body, which allows a one-piece design of the wear body or dewatering element. In particular, the labour-intensive design of the wear body from a large number of surface-ground ceramic plates, which is particularly familiar from the prior art, can be dispensed with. Equally advantageous, the embodiments allow the wear body to be recycled. The application of correspondingly high temperatures leads to the polymer substrate of the wear body being decomposed or degraded and the ceramic particles being released or made available again as a recyclable material. This is particularly advantageous as the properties of the wear body are not adversely affected by this temperature build-up. In particular, there is no need to grind up the wear bodies to be recycled, which means that the particle size distribution and particle diameter of the ceramic particles are not adversely affected.

Advantageously, the polymer substrate of the dewatering element is designed as a duromer. Duromers are synthetic material that can no longer be deformed by heating or other measures once they have hardened. This is particularly advantageous, as considerable amounts of heat can be introduced into the wear body as a result of the frictional power transferred from the clothing to the dewatering element. The polymer substrate, which is designed as a duromer, thus allows dimensional stability and operational strength to be maintained at typical operating temperatures or design temperatures of dewatering elements. Duromers can be permanently thermally stable up to a temperature of <=100° C., preferably <=80° C., i.e. they do not soften. After the duromers have hardened, however, further processing can be carried out by machining. In general, duromers are characterised by high mechanical strength, whereby these strength properties are essentially unaffected by temperature. In particular, duromers allow very good integration of ceramic particles, as duromers have an advantageously high adhesive strength and are therefore an ideal polymer substrate. In particular, the polymer substrate designed as a duromer gives the wear body an advantageously low coefficient of friction and thus low frictional resistance. In addition, it is possible to design the wear body in a particularly simple way, e.g. by manufacturing the wear body in a casting process, in particular in a vacuum casting process. The casting can take place at room temperature, for example. The wear body produced in this way already has very smooth surfaces after casting, which means that post-processing of the surfaces can be dispensed with or is only necessary to a limited extent. The production in a casting process also allows great flexibility with regard to the realisable geometry of the wear body. This means that curved geometries, such as the blades for forming shoes, can be easily realised. In addition, local defects in the wear body can also be easily repaired using a casting process.

The wear body of the dewatering element is also advantageously made of a ceramic-reinforced polymer synthetic resin, in particular epoxy resin, in particular using a casting process. The substrate is formed from the synthetic resin, whereby a vacuum casting process is particularly advantageous. The casting can take place at room temperature, for example. Synthetic resins are, for example, precursors, i.e. prepolymers, for the formation of duromers. Advantageously, these precursors are liquid or soluble and can be easily mixed with fillers, especially ceramic particles. This makes it possible to simply form the wear body, in particular by forming the wear body using a casting process, whereby the synthetic resin is cast together with the embedded ceramic particles. Typically, the prepolymers are polymerised and cross-linked with the aid of hardeners and possibly catalysts. Particularly advantageous is the use of an epoxy resin system as a polymer synthetic resin, as this allows the ceramic particles to be incorporated in a favourable way. After mixing with a hardener, the epoxy resin system reacts to form a duromer and, after curing, exhibits favourable mechanical properties and temperature resistance.

A preferred embodiment is characterised in that the mass fraction of the ceramic particles in the ceramic-reinforced polymer substrate is 60%-99%, in particular 70%-98% and particularly advantageously 80%-96%. In this case, a higher mass fraction of ceramic particles goes hand in hand with a higher wear resistance of the wear body. A higher polymer substrate content, in turn, is advantageous in terms of the impact resistance and toughness of the wear body. Thereby the mass fraction of ceramic particles in the wear body is limited upwards in order to ensure homogeneous incorporation of the ceramic particles in the polymer substrate.

A further preferred embodiment is characterised in that the incorporated ceramic particles are formed from Si-carbide, Si-nitride, Al-oxide, Zr-oxide or zirconium dioxide-reinforced aluminium oxide. These specific ceramics are particularly favourable in terms of their wear resistance. Advantageously, all ceramic particles in a wear body consist of the same specific ceramic. Ceramic particles of different specific ceramics can also be advantageously present in a wear body.

An embodiment is characterised in that the ceramic particles have a diameter, in particular measured by laser diffraction according to ISO 13320: 2020, the diameter of the ceramic particles is less than 1.5 mm and in particular less than 1 mm and the diameter of the ceramic particles is most frequently between 0.1 mm and 0.4 mm and in particular between 0.2 mm and 0.3 mm. Excessively large diameters of the ceramic particles should be avoided, as larger particles are more likely to break out of the polymer substrate or the sliding surface during operation. The ceramic particles are preferably polydisperse, whereby a mixture of ceramic particles with different diameters is present. Polydisperse ceramic particles can be embedded particularly well in the polymer substrate, whereby a high space filling by the ceramic particles in the polymer substrate is possible and a low mass fraction of the polymer substrate in the wear body allows a secure integration of the ceramic particles in the wear body.

A further embodiment is characterised in that the dewatering element is designed for use in a machine for producing the fibrous web, in particular a paper or pulp web. The dewatering element is preferably designed as a blade, in particular as a scraper blade, dewatering blade, forming blade, or as a cover, in particular as a wire table cover, moulding cover, suction strip cover, wet suction cover, transfer suction cover, felt suction cover or as a perforated plate for dewatering. Typically, the dewatering element or blade extends across the entire working width of the clothing or the working width of the machine. The dewatering elements can also be arranged in the machine direction, i.e. in the direction of movement of the clothing, in which case a plurality of dewatering elements are arranged transversely to the machine direction, forming a dewatering device, in particular a forming shoe.

In an advantageous design of the dewatering element, the wear body is designed in one piece, in particular over a working width of the cover. The working width of the machine essentially corresponds to the working width of the clothing or the width of the fibrous web. A one-piece design of the wear body across the entire working width of the clothing is advantageous, as the modular design of the wear body using ceramic plates known from the state of the art is very complex and labour-intensive and can be dispensed with. This one-piece production across the working width is made possible by the design of the wear body as a ceramic-reinforced polymer substrate, whereby the wear body can be produced in one piece across the entire working width, particularly in a casting process.

In an advantageous design of the dewatering element, the wear body is designed in one piece, in particular over a working width of the clothing. The parts of the wear body are lined up to form the dewatering element. The subdivision of the wear body or dewatering element makes it easier to deliver the dewatering element from the production site to the place of use. Due to the design of the wear body as a ceramic-reinforced polymer substrate, it is easy to divide the wear body into longer parts. Preferably, the dewatering element comprises a wear body, whereby the wear body is divided into a maximum of 10 parts across the working width of the clothing, further advantageously into a maximum of 8 parts and particularly advantageously into a maximum of 6 parts. Advantageously, the parts of the wear body are connected by bonding and/or form-fit. The connection by form-fit can take the form of form-fit interlocking parts of the wear body in particular. The combination of adhesive bonding and form closure enables a particularly strong connection between the parts of the wear body.

In an embodiment, the wear body of the dewatering element is also designed as a supporting bar for mounting in a frame. In the state of the art, ceramic elements or plates are built up to form a wear body, which is connected to a supporting bar. The dewatering element designed in this conventional way can be accommodated in a frame via the supporting bar. Due to the design of the wear body as a ceramic-reinforced polymer substrate, the wear body can be manufactured very easily and, in particular, complex geometries, such as for the design of the wear body as a supporting bar, can be realised easily and cost-effectively. In particular, the wear body can be manufactured in a casting process, which means that there are hardly any restrictions in terms of shape.

In an equally advantageous embodiment, the dewatering element comprises, in addition to the wear body, a supporting bar, in particular made of fibre-reinforced plastic or polymer substrate. The design of supporting bars made of fibre-reinforced plastic is favourable. Advantageously, however, the supporting bar can also be made from the polymer substrate, whereby the inclusion of ceramic particles in the supporting bar can be dispensed with. This offers the advantage that the polymer substrate has good strength, in particular impact resistance, and good toughness or reduced brittleness. The wear body and supporting bar can be connected by form-fit and/or force-fit. Force-fit can be achieved by bonding, for example, whereby a combination of form-fit and force-fit results in a particularly resilient connection. In a particularly preferred embodiment, the wear body is applied to the supporting bar in a casting process-forming a form-fit and/or force-fit connection.

The subject matter also relates to a dewatering device for dewatering a fibrous web in a machine for producing a paper or pulp web, wherein the dewatering device comprises at least one dewatering element. In particular, the dewatering device can be designed as a forming shoe, wire table, suction box, especially a wet suction box, transfer suction box, felt suction box, flat suction box, etc. When forming a wire table, dewatering elements are typically designed as blades at right angles to the machine direction. A forming shoe is typically constructed from dewatering elements that are aligned in the machine direction, with a plurality of dewatering elements arranged transverse to the machine direction to form the dewatering device.

### BRIEF DESCRIPTION OF THE DRAWINGS

The invention will now be described using the examples in the drawings.

FIG. 1 shows a machine for the production of a paper or pulp web with dewatering device and dewatering elements according to the state of the art.

FIG. 2 shows a dewatering device with dewatering elements according to the state of the art.

FIG. 3 shows a dewatering element according to the state of the art.

FIG. 4 shows a dewatering element according to the disclosure.

FIG. 5 shows another dewatering element according to the disclosure.

### DETAILED DESCRIPTION

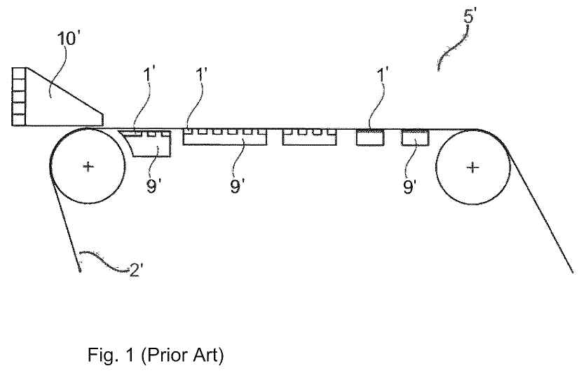

FIG. 1 shows a machine 5′ for the production of a paper or pulp web with dewatering devices 9′ and dewatering elements 1′ according to the state of the art, whereby a fourdrinier or fourdrinier former is shown. A fibre suspension is applied to a clothing 2′ via a headbox 10′ and passed through various dewatering devices 9′, e.g. the wire table, dewatering boxes with blade-shaped dewatering elements and dewatering boxes with cover-shaped dewatering elements, for dewatering. The fibrous web is dewatered by the clothing 2′, whereby the clothing 2′ is in direct contact with the dewatering elements 1′ and slides over the dewatering elements 1 and wears them down.

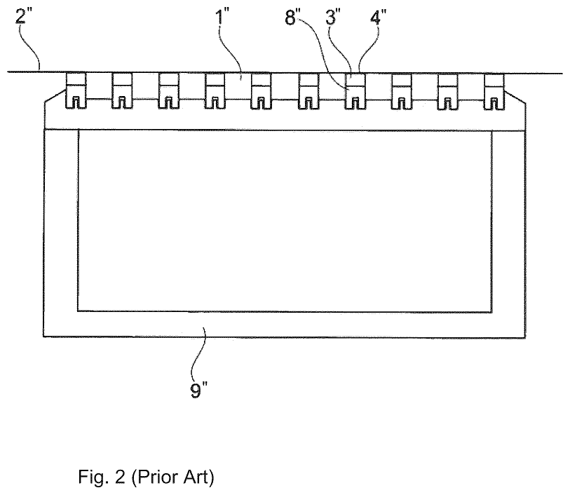

FIG. 2 shows a dewatering device 9″ with dewatering elements 1″ according to the state of the art, whereby a dewatering box with blade-shaped dewatering elements 1″ is shown. The fibrous web lying on the clothing 2″ is guided over the dewatering elements 1″ and dewatered in the process. The individual dewatering element 1″ is designed here as a blade or dewatering blade and comprises a wear body 3″, which forms a sliding surface 4″, whereby the clothing 2″ is guided in direct contact with the sliding surface 4″ for dewatering the fibrous web. In the state of the art, the wear bodies 3″ are composed of sintered ceramic plates. The dewatering element 1″ also comprises a supporting bar 8″, whereby the dewatering element 1″ is connected to a frame or the box via the supporting bar 8″. The connection between the ceramic wear body 3″ and the supporting bar 8 is made, for example, by bonding.

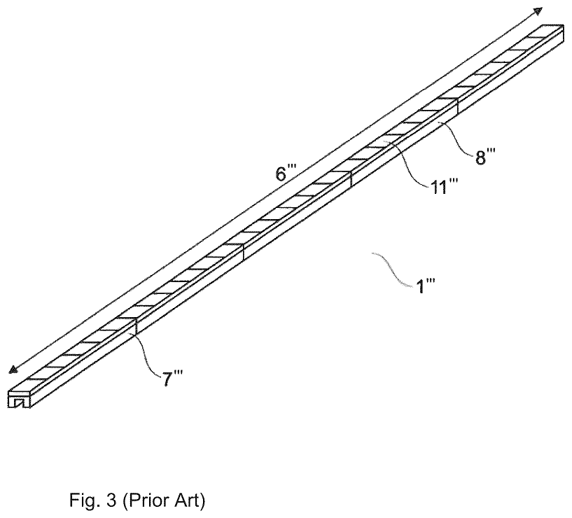

FIG. 3 shows a dewatering element 1″′ according to the state of the art. The illustration covers the entire working width 6″′ of the machine or the clothing 2″′. In the state of the art, the wear body 3″′ is designed as a sintered ceramic, whereby the wear body 3″′ is constructed in detail from individual ceramic plates 11″′, whereby the ceramic plates 11″′ are lined up and joined together.

FIG. 4 shows an embodiment of the disclosed dewatering element 1, which is designed as a dewatering blade. The wear body 3 is designed as a ceramic-reinforced polymer substrate, with ceramic particles being incorporated into the polymer substrate. In particular, the polymer substrate is designed as a duromer, whereby the wear body 3 is manufactured from a ceramic-reinforced polymer synthetic resin, in particular epoxy resin, using a casting process. The mass fraction of ceramic particles in the ceramic-reinforced polymer substrate is advantageously 80%-96%. In addition to the wear body 3, the dewatering element 1 comprises a supporting bar 8 for connecting the dewatering element 1 to a frame (not shown). The supporting bar 8 can be made of fibre-reinforced plastic, but in particular also of the polymer substrate. The connection between the wear body 3 and the supporting bar 8 in the dewatering element 1 shown, is made by form-fit and force-fit, with the form closure being provided by a dovetail connection. The wear body 3 is applied to the supporting bar 8 using the casting process, whereby the wear body 3 and the form-fit and force-fit connection with the supporting bar 8 is formed. The illustrated dewatering element 1 and in particular the wear body 3 can be in one piece or divided into parts across the working width 6 of the clothing or the machine.

FIG. 5 shows an embodiment of the disclosed dewatering element 1, which is also designed as a dewatering blade. The dewatering element 1 shown here differs from the embodiment shown in FIG. 4 in that the wear body 3 is also designed as a supporting bar 8 for mounting in a frame. Advantageously, the dewatering element 1 comprising the wear body 3 and the supporting bar 8 can be manufactured in a single manufacturing step, e.g. by a casting process. The dewatering element 1 shown is advantageously in one piece or divided into parts across the working width 6 of the clothing 2 or the machine 5.

The disclosed embodiments offer numerous advantages. The dewatering element, in particular its wear body, can be produced simply and in a less labour-intensive manner, whereby the wear body can be produced for the respective width of the paper machine and, in particular, can be produced in one piece over the entire width of the clothing or machine. There is also great flexibility with regard to the realisable geometry of the wear body. This means that curved geometries can be easily realised, e.g. using a casting process. In particular, the embodiments achieve a synergistic effect, whereby a wear body formed as a ceramic-reinforced polymer substrate has an advantageously high resistance to abrasion and also has improved strength, in particular impact resistance, improved toughness or reduced brittleness, and a low coefficient of friction or low frictional resistance. In addition, local defects in the wear body can be easily repaired. Furthermore, the recyclable materials contained in the wear body, i.e. the ceramic particles, can be easily recycled after use without any detrimental change to the ceramic particles, whereby the ceramic particles can subsequently be used again in the manufacture of wear bodies for dewatering elements.

### REFERENCE NUMERALS

(1) Dewatering element
(2) Clothing
(3) Wear body
(4) Sliding surface
(5) Machine
(6) Working width
(7) Part
(8) Supporting bar
(9) Dewatering device
(10) Headbox
(11) Ceramic plate

1-15. (canceled)

16. A dewatering element (1) for dewatering a fibrous web guided on a clothing (2) over the dewatering element (1), comprising
a wear body (3) forming a sliding surface (4), configured for the clothing (2) to be guided over in direct contact with the sliding surface (4) for dewatering the fibrous web, wherein
the wear body (3) is designed as a ceramically reinforced polymer substrate with ceramic particles incorporated therein,
the polymer substrate is a duromer, and
the mass fraction of the ceramic particles in the ceramic-reinforced polymer substrate is within an approximate range of 80-96%.

17. The dewatering element (1) according to claim 16, wherein
the dewatering element (1) is configured for use in a machine (5) for producing the fibrous web, and
the dewatering element (1) is configured as a blade or as a cover.

18. The dewatering element (1) according to claim 17, wherein the dewatering element (1) is configured as a blade selected from the group consisting of a scraper blade, dewatering blade, and forming blade.

19. The dewatering element (1) according to claim 17, wherein the dewatering element (1) is configured as a cover selected from the group consisting of a wire table cover, forming cover, suction strip cover, wet suction cover, transfer suction cover, felt suction cover, and a perforated cover.

20. The dewatering element (1) according to claim 16, wherein the wear body (3) is a single integral piece

21. The dewatering element (1) of claim 20, wherein the wear body (3) extends over a working width (6) of the clothing (2).

22. The dewatering element (1) according to claim 16, wherein
the wear body (3) comprises multiple parts (7) over a working width (6) of the clothing (2), and
the parts (7) are aligned to form the wear body (3).

23. The dewatering element (1) according to claim 17, wherein
the wear body (3) comprises multiple parts (7) over a working width (6) of the clothing (2), and
the parts (7) are aligned to form the wear body (3).

24. The dewatering element (1) according to claim 22, wherein the multiple parts (7) of the wear body (3) are connected via bonding or are form-fit or both.

25. The dewatering element (1) according to claim 24, wherein the multiple parts (7) are connected via form fit and the multiple parts (7) interlock with each other to form the wear body (3).

26. The dewatering element (1) according to claim 16, wherein the wear body (3) is also configured as a supporting bar (8) for mounting in a frame.

27. The dewatering element (1) according to claim 16, further comprising a supporting bar (8), wherein the wear body (3) and the supporting bar (8) are connected via form-fitting or force-fitting or both and the supporting bar (8) is configured for mounting in a frame.

28. The dewatering element (1) according to claim 27, wherein the supporting part is formed from a fiber-reinforced plastic or a polymer substrate.

29. The dewatering element (1) according to claim 27, wherein the wear body (3) is applied to the supporting bar (8) in a casting process.

30. The dewatering element (1) according to claim 16, wherein the ceramic particles comprise one or more selected from the group consisting of Si-carbide, Si-nitride, Al-oxide, Zr-oxide, and zirconium dioxide-reinforced Al-oxide.

31. The dewatering element (1) according to claim 16, wherein the ceramic particles have a diameter less than 1.5 mm.

32. The dewatering element (1) of claim 31, wherein the ceramic particles have a diameter within an approximate range of 0.1-0.4 mm.

33. The dewatering element (1) according to claim 16, wherein the wear body (3) is manufactured from a ceramic-reinforced polymer synthetic resin.

34. A dewatering device (9) for use in a machine (5) for producing the fibrous web, comprising at least one dewatering element (1) according to claim 16.

35. A dewatering device (9) according to claim 34, wherein the dewatering device (9) is configured as a forming shoe, wire table, suction box, especially a wet suction box, transfer suction box, felt suction box, or flat suction box.
